(19) United States
(12) Patent Application Publication
(10) Pub. No.: US 2026/0133972 A1
(43) Pub. Date: May 14, 2026

(54) Responding to User Queries

(71) Applicant: Sage Global Services Limited, Newcastle Upon Tyne (GB)

(72) Inventor: Srijith Rajamohan, Crozet, VA (US)

(21) Appl. No.: 18/946,024

(22) Filed: Nov. 13, 2024

(51) Int. Cl. G06F 16/2455; G06F 16/2453

(52) U.S. Cl. CPC G06F 16/2455; G06F 16/24534

(57) ABSTRACT

A computer system for responding to user queries. The system includes: a coordinating agent configured to receive from a source device a user query, and a constrained set of function-implementing agents, each function-implementing agent configured to perform a function. Upon receipt of the user query, the coordinating agent is configured to: formulate a plan to generate a response to the user query, the plan including a sequence in which one or more of the function-implementing agents will be invoked to perform their associated function, and execute the plan by controlling the function-implementing agents in accordance with the sequence to generate the response to the user query. The constrained set of function-implementing agents includes a closed group of function-implementing agents.

### TECHNICAL FIELD

The present invention relates to techniques for responding to user queries.

### BACKGROUND

In recent years, artificial intelligence (AI) and machine learning technologies have made significant strides, leading to the development of AI-powered tools capable of automating complex problem-solving and data analysis tasks. These advancements promise substantial productivity gains for users by streamlining workflows and handling tasks that traditionally required considerable human effort.

Despite these advances, a persistent challenge remains: even the most sophisticated AI systems can produce incorrect or inconsistent results. This issue, often referred to as “hallucination,” occurs when an AI system generates outputs that are plausible but inaccurate or nonsensical. Such errors undermine the reliability of AI tools and erode user trust, limiting their widespread adoption in critical applications. Compounding this issue is the fact that many advanced AI systems operate in an ‘unconstrained’ manner. Specifically, these systems may have extensive access to vast sources of information, such as the internet, and can perform data processing using a wide array of tools without strict limitations or oversight. The way these systems access data and execute processing tasks is often not tightly regulated, allowing them to utilise any appropriate tools in any order or method. This lack of constraints means they may perform tasks not directly intended by the user or execute tasks in unexpected ways. Such unpredictability reduces the control users have over the AI's actions and diminishes the accuracy of the outputs. Consequently, users may hesitate to rely fully on AI-driven assistance, hindering the potential productivity benefits these technologies offer.

There is a need for AI systems that provide more reliable and consistent outputs. Enhancing the trustworthiness of AI tools is important for users to confidently integrate them into their workflows. By minimising inaccuracies and ensuring outputs align closely with user intentions, AI technologies can realise their full potential in boosting productivity and efficiency across various domains.

### SUMMARY OF THE INVENTION

In accordance with a first aspect of the invention, there is provided a computer system for responding to user queries. The system comprises: a coordinating agent configured to receive from a source device a user query, and a constrained set of function-implementing agents, each function-implementing agent configured to perform a function. Upon receipt of the user query, the coordinating agent is configured to: formulate a plan to generate a response to the user query, the plan comprising a sequence in which one or more of the function-implementing agents will be invoked to perform their associated function, and execute the plan by controlling the function-implementing agents in accordance with the sequence to generate the response to the user query. The constrained set of function-implementing agents comprises a closed group of function-implementing agents.

Optionally, the function performed by each function-implementing agent is one of a data retrieval function and a data processing function.

Optionally, the function performed by one or more of the function-implementing agents is a data retrieval function or a data processing function optimised for a predetermined domain.

Optionally, the coordinating agent further comprises an analysis module, said analysis module configured to analyse the user query to determine if it contains sufficient information to formulate the plan, and if not, the coordinating agent is configured to undertake a clarification process to obtain further information to augment the user query with further information.

Optionally, the coordinating agent further comprises a RAG system with access to a data repository, wherein the coordinating agent is configured to undertake the clarification process by controlling the RAG system to: identify if further information is present in the data repository to augment the user query and, if such further information is identified, augment the user query with the further information, wherein the coordinating agent is configured to then formulate the plan to generate a response to the augmented user query.

Optionally, if the RAG system does not identify further information in the data repository to augment the user query, the coordinating agent is configured to: generate a further information request requesting further information to clarify the user query; communicate the further information request to the source device from which the user query was received, and on receipt of a further information response comprising further information, and augment the user query with the further information, wherein the analysis module is configured to then analyse the augmented user query to determine if it now contains sufficient information to formulate the plan, and if so the coordinating agent is configured to then formulate the plan to generate a response to the augmented user query.

Optionally, the source device is a user device operable by a user.

Optionally, the coordinating agent is implemented on a server system remote from the source device.

Optionally, the domain is accounting and finance.

Optionally, the coordinating agent is configured to generate the plan using a generative AI model.

In accordance with a second aspect of the invention, there is provided a computer implemented method of responding to user queries. The method comprises: receiving a user query from a source device; formulating a plan to generate a response to the user query, the plan comprising a sequence in which one or more function-implementing agents of a constrained set of function-implementing agents will be invoked to perform a function, and executing the plan by controlling the function-implementing agents in accordance with the sequence to generate the response to the user query. The constrained set of function-implementing agents comprises a closed group of function-implementing agents.

Optionally, the function performed by each function-implementing agent is one of a data retrieval function and a data processing function.

Optionally, the function performed by one or more of the function-implementing agents is a data retrieval function or a data processing function optimised for a predetermined domain.

Optionally, the method further comprises: analysing the user query to determine if it contains sufficient information to formulate the plan, and if not, undertaking a clarification process to obtain further information to augment the user query with further information.

Optionally, the step of undertaking the clarification process comprises controlling a RAG system to: identify if further information is present in the data repository to augment the user query and, if such further information is identified; augment the user query with the further information, and then formulate the plan to generate a response to the augmented user query.

Optionally, if the RAG system does not identify further information in the data repository to augment the user query, the method further comprises: generating a further information request requesting further information to clarify the user query; communicating the further information request to the source device from which the user query was received, and on receipt of a further information response comprising further information, augmenting the user query with the further information, then analysing the augmented user query to determine if it now contains sufficient information to formulate the plan, and if so, formulating the plan to generate a response to the augmented user query.

Optionally, the source device is a user device operable by a user.

Optionally, the domain is accounting and finance.

Optionally, the method comprises generating the plan using a generative AI model.

In accordance with embodiments of the invention, an AI-based agent system for providing responses to user queries or for performing user-defined tasks is provided.

The system comprises a coordinating agent which controls a constrained set of “function-implementing agents” to generate a response to a user query. The function-implementing agents are constrained in that they are a closed group of function-implementing agents (e.g. the architecture doesn't have access to open-ended number of resources as is the case in conventional systems that might have access to tools via e.g. the internet), and each function-implementing agent is specialised to perform a particular function (e.g. retrieve data from a data repository or perform a deterministic data processing function). Typically, some or all of these data processing functions are optimised for a specific domain.

The coordinating agent generates responses to user queries by generating a plan which comprises a sequence of steps in which the constrained set of function-implementing agents are used.

Restricting the available functions to a closed set of function agents and predefining their execution order limits the resources for responding to user queries and restricts their usage. However, since these agents operate within established parameters, the likelihood of producing erroneous data or responses is substantially minimized. The system's limitations due to restricted access to non-constrained resources and the inability to create open-ended plans are generally acceptable for domain-specific queries, as such tasks are usually narrower in scope and more targeted. This makes it feasible to depend on a limited group of highly specialised function-implementing agents. Consequently, examples of this invention typically demonstrate enhanced performance in managing domain-specific user queries.

Various further features and aspects of the invention are defined in the claims.

### BRIEF DESCRIPTION OF THE DRAWINGS

Embodiments of the present invention will now be described by way of example only with reference to the accompanying drawings where like parts are provided with corresponding reference numerals and in which:

FIG. 1 provides a simplified schematic diagram depicting the functional elements of a system for responding to user queries in accordance with certain embodiments of the invention;

FIG. 2 provides a diagram depicting a process to generate a response to a user query performed by the system shown in FIG. 1 in accordance with certain examples of the invention, and

FIG. 3 provides a simplified schematic diagram depicting an example implementation of a system in accordance with certain examples of the invention.

### DETAILED DESCRIPTION

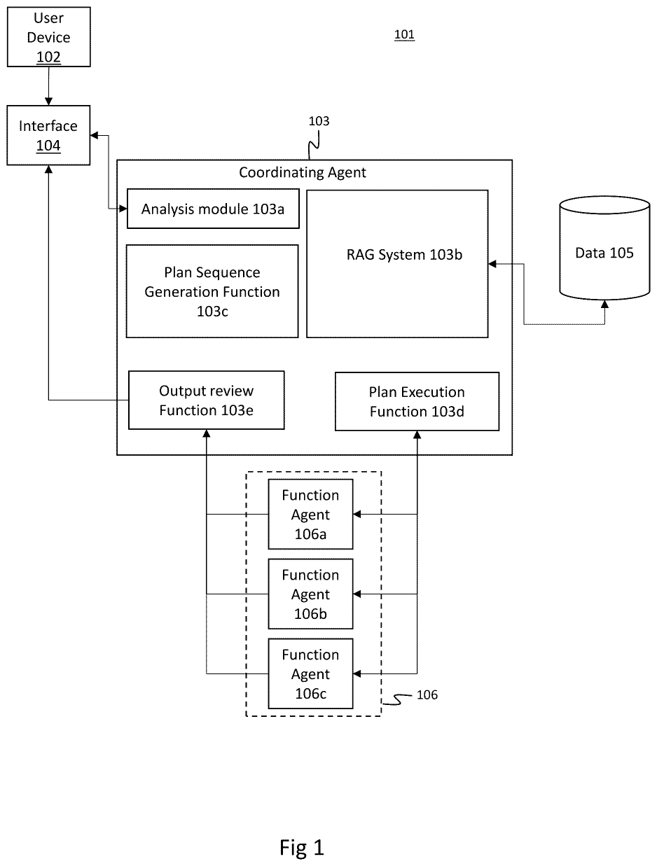

FIG. 1 provides a simplified schematic diagram depicting the functional elements of a system 101 for responding to user queries in accordance with certain embodiments of the invention.

User queries in the context of examples of the invention are typically queries associated with data retrieval or data processing. For example, in the context of accounting and finance, a user query may be a request from a user to retrieve certain types of data or a specific data item. Such a query might involve accessing stored information within the data repository 105, such as retrieving a specific transaction history or retrieving details of a particular product or service. A data processing query may be a request to generate a particular metric from stored data values combined with data values provided by the user. For example, a user might request an analysis of sales performance by providing recent sales figures to be amalgamated with historical data stored in the system, thereby allowing the generation of insights such as trends, averages, and predictions.

The system 101 comprises a user device 102 communicatively connected to a coordinating agent 103 via an interface 104.

The coordinating agent 103 is connected to a data repository 105 and also a plurality of function-implementing agents 106.

The coordinating agent 103 comprises an analysis module 103a, a RAG system 103b, a plan sequence generation function 103c, a plan execution function 103d and an output review function 103e.

In use, the coordinating agent 103 is configured to receive a user query from a source device (the user device 102) via the interface 104, ensure it contains sufficient information to generate a response plan sequence to respond to the user query using the plurality of function-implementing agents 106, generate and execute the response plan sequence and then communicate an appropriate response to the user device 102.

More specifically, the analysis module 103a is configured to analyse the user query to determine if it contains sufficient information to generate the response plan sequence and if not, it is configured to initiate a clarification process to obtain further information to augment the user query with further information. To initiate this process, the analysis module 103a is configured to request the RAG system 103b seeks further information from the data repository 105 to augment the user query. If the RAG system 103b does not identify any such information, the analysis module 103a is configured to generate a request for further information which is then communicated to the user device 102. A response from the received from the user device 102 providing this further information can then be used to augment the original user query.

The original user query, or augmented user query is then passed to the plan sequence generation function 103c which generates a response plan. The response plan sequence defines a sequence in which the function-implementing agents are invoked to carry out their specific functions in order to generate a response to the user's query.

This response plan sequence is then passed to the plan execution function 103d which controls the plurality of function-implementing agents 106 to generate a response to the user query by executing the response plan.

The level of intelligence of the function-implementing agents 106 may vary between different embodiments. In some cases, a function-implementing agent may be equipped with its own controlling AI model, such as a suitably configured large language model (LLM). In such cases, the function-implementing agent may only require minimal input, such as the output from a preceding function-implementing agent or initiating information, along with an indication of the expected output. This allows the function-implementing agent to autonomously determine the necessary steps to fulfil its role in the response plan.

In other embodiments, where the function-implementing agent has limited or no intelligence, more detailed and precise instructions may be provided within the response plan. These instructions may specify the exact input required, as well as the precise operations to be performed by the function-implementing agent, to ensure that the function-implementing agent can fulfil its function in the sequence.

The eventual output generated by the plurality of function-implementing agents 106 is reviewed by the output review function 103e and then communicated back to the user device 102 via the interface 104.

As explained in more detail below, the system 101, and in particular the coordinating agent 103, data repository 105 and plurality of function-implementing agents 106 are typically optimised to handle “domain-specific” user queries. In other words, systems in accordance with examples of the invention are typically configured to generate responses to user queries s that relate to data retrieval and data processing tasks belonging to a particular field, for example a particular commercial, technical, financial, scientific, medical, legal, or administrative field.

The analysis module 103a, which is configured to determine if the original user query and any subsequent augmented user query contains sufficient information to formulate a response plan sequence, can be implemented in any suitable way. In typical examples, the analysis module 103a uses an appropriate machine learning model, such as a large language model (LLM) to assess the sufficiency of the query, i.e. to evaluate the content of the user query to determine whether enough information is present to proceed. typically, to implement this approach, the analysis module 103a is configured to generate a query to pass to the LLM, including the user query and an instruction to identify any terms or other aspects of the query that are unclear or where insufficient information is provided.

However, as the skilled person will understand, further techniques could also be employed in combination with or as alternative to implement the analysis module 103a: For instance, the analysis module 103a could implement a rules-based process in which the user query is analysed with respect to a set of predefined rules, such as keyword matching or template structures, and in which the query is flagged as insufficient if key elements are absent. Alternatively, a custom machine learning model could be trained specifically for this purpose, which could classify the sufficiency of user queries s based on prior examples. Alternatively, or additionally, the analysis module 103a could apply heuristic-based evaluation, using a scoring system to assess the completeness of the query by assigning a score based on the inclusion of critical information and flagging queries that fall below a certain threshold. Alternatively, or additionally, the analysis module 103a could reference an ontology or knowledge graph to map the content of the query, determining sufficiency by verifying that all necessary concepts and relationships are present in the user input.

The RAG system 103b is typically implemented using a combination of information retrieval and query augmentation techniques. Initially, the RAG system 103b queries the data repository 105 to retrieve relevant information that can help clarify the original user query. This retrieval process may involve conventional keyword matching, semantic searching, or more advanced methods using, for example, embedding-based models, which analyse the meaning of the query to find semantically similar information.

Once relevant data is retrieved, the RAG system 103b is configured to augment the original user query by incorporating the additional information. This augmentation can be performed using rule-based systems or a suitable machine learning model, which intelligently enhances the query by filling in missing details or clarifying ambiguous aspects. As detailed below, the augmented query is then returned to the analysis module 103a for reassessment to determine if it now contains sufficient information to formulate a response plan sequence.

As mentioned above, the system 101 is typically configured to handle user queries relating to a particular domain, and consequently, the data repository 105 accessed by the RAG system 103b typically contains domain-specific data that can be used to augment such queries s. For example, in a financial domain, the data repository 105 might store transaction records, financial statements, tax documents, and other relevant data. The data repository 105 may also contain specialised reference materials, definitions of technical terms, and guidelines relevant to the domain. For example, the repository might include legal or regulatory frameworks such as tax laws, financial reporting standards, domain-specific glossaries covering technical terms like “EBITDA” or capital gains, and procedural guidelines for compliance and auditing. In addition to domain-specific data, the data repository 105 may also include customised data related to particular organisations, such as a particular company or group of companies. This might encompass specialised reference materials, definitions, and terms that are used by that organisation (for example its own set of acronyms, jargon, and procedural guidelines) and not widely recognised outside of it.

The plan sequence generation function 103c is implemented in any suitable way to generate a sequence in which a plurality of function-implementing agents are used to generate a response to the user query. For example, the plan sequence generation function 103c may use a large language model (LLM), which takes as input the user query or augmented user query along with the specifications of each function-implementing agent, such as their input and output types and the specific tasks they perform. The LLM analyses the query and determines the most appropriate sequence in which the function-implementing agents should be invoked, ensuring that their outputs feed into subsequent agents as required. Alternative implementation strategies are possible, for example, the plan sequence generation function 103c could be implemented using a custom model that has the functionality of the function-implementing agents embedded within it, allowing the model to generate a plan sequence based on its internal understanding of the agents'capabilities. In other embodiments, rule-based systems could be used, where predefined rules map certain types of queries to specific sequences of function-implementing agents.

The plan execution function 103d is implemented in any suitable way to execute the plan sequence generated by the plan sequence generation function 103c. For example, the plan execution function 103d may take the generated plan sequence, which outlines the specific function-implementing agents to be used and the order in which they are invoked, and ensure that each function-implementing agent is activated at the appropriate time. This may involve sequentially passing the outputs of one function-implementing agent as inputs to the next, thereby coordinating the flow of data between agents. In some implementations, the plan execution function 103d may monitor the progress of each agent's execution to ensure that it completes successfully and may handle errors or retries if an agent fails to perform its designated task. In other embodiments, the plan execution function 103d may operate asynchronously, allowing function-implementing agents to execute in parallel when tasks are independent, thereby improving efficiency. In certain embodiments, the plan execution function 103d may also manage resource allocation and ensure that each function-implementing agent has the necessary computational resources to perform its operation.

The output review function 103e can be implemented in any suitable way, for example, by using a large language model (LLM) to evaluate the generated response for completeness, relevance, and appropriateness based on predefined quality thresholds. The LLM could assess the response for compliance with content guidelines, such as checking for the presence of confidential information or inappropriate language. Alternatively, the output review function 103e could be implemented using a rule-based system, where specific criteria are applied to evaluate the response's accuracy and suitability. In other embodiments, a custom machine learning model could be used, trained specifically to flag issues such as incomplete responses or content violations.

Each function-implementing agent of the plurality of function-implementing agents 106 is configured to perform a specific data retrieval or data processing task. Typically, some or all of the plurality of function-implementing agents 106 are configured to perform specialised tasks associated with the domain for which the system 101 is optimised. For example, in examples in which a system 101 is optimised for accounting operations, a data retrieval function-implementing agent might be configured to access certain data resources, for example databases containing transaction histories balance sheet data, tax data and so on and so on. Similarly, a data processing function-implementing agent could be responsible for performing ledger posting tasks.

In certain examples, the functions performed by the function-implementing agents are deterministic, meaning for a given input they produce consistent and predictable results every time they are executed. This deterministic nature ensures reliability and accuracy in operations, which is critical for domains like finance and accounting. For instance, tasks such as transaction history retrieval, balance sheet data extraction, and tax records retrieval follow strict protocols to ensure that precise data is consistently fetched. Similarly, tasks like financial statement generation, ledger posting, and depreciation calculations adhere to predefined rules, ensuring consistency and compliance with regulatory standards.

While the overall plan sequence may be formulated using potentially non-deterministic techniques—such as generative models—the execution of individual function-implementing agents for certain functions can be deterministic. This guarantees that, despite any non-deterministic processes involved in generating the sequence, the final output is based on consistent, reliable, and accurate operations performed by the function-implementing agents.

The function-implementing agents 106 can be implemented in a variety of ways, depending on the specific data retrieval or data processing tasks they are designed to perform and the domain in which they operate. In one embodiment, each function-implementing agent could be implemented as a specialised software module or microservice, designed to interact with specific data repositories or processing systems within its designated domain. For example, in a financial system, a function-implementing agent responsible for transaction history retrieval might be a microservice that communicates with a financial database via a secure API to fetch records. Similarly, a function-implementing agent designed for ledger posting could be a specialised module that interfaces with an accounting software platform to apply specific financial entries according to predefined rules.

In more advanced implementations, function-implementing agents might be powered by machine learning models or other AI technologies, especially when performing more complex data processing tasks. However, in these cases, where necessary, the models would be trained to perform deterministic functions, ensuring that the same input consistently results in the same output. For instance, a machine learning-based function-implementing agent might be trained to identify and process specific types of financial data in large datasets, but its operation would remain predictable and repeatable, following the constraints of its training.

In some embodiments, function-implementing agents could also interact with external systems, such as cloud-based data repositories or third-party APIs, to retrieve or process information. These agents would be provided with suitable communication protocols to ensure that data is retrieved and processed accurately and securely, adhering to any necessary domain-specific regulations and compliance standards.

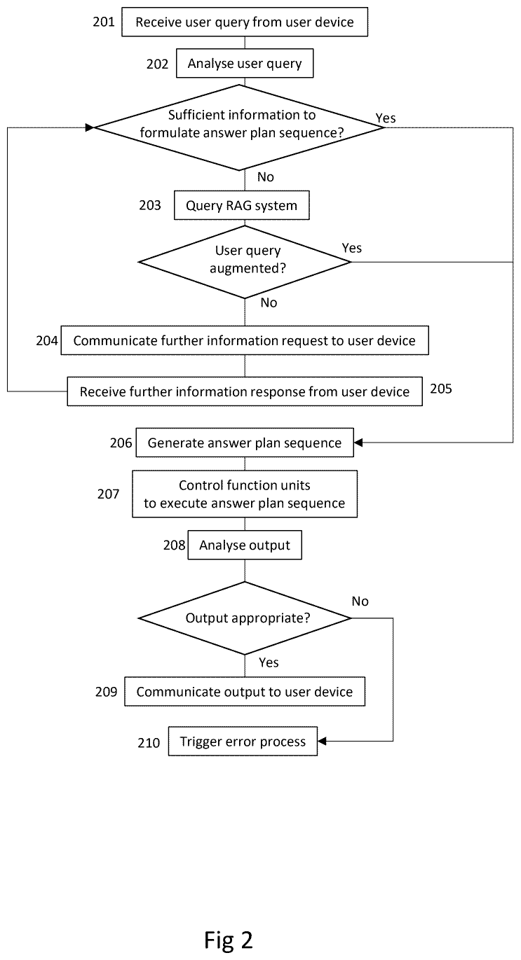

FIG. 2 provides a diagram depicting a process to generate a response to a user query performed by the system 101 shown in FIG. 1 in accordance with certain examples of the invention.

At a first step 201, a user query is received from the user device 102, via the interface 104 at the coordinating agent 103.

At a second step 202, the analysis module 103a is configured to analyse the user query to determine if it contains sufficient information to formulate a response plan sequence. If this is the case, the process proceeds to a sixth step 206 explained in more detail below.

However, if the analysis module 103a determines that this is not the case, then it communicates the user query, or a relevant part of the user query to the RAG system 103b.

At a third step 203 the RAG system 103b then queries the data repository 105 to determine if it contains any further information with which to clarify or supplement the user query. If the RAG system 103b retrieves such information from the data repository 105, the RAG system 103b then suitably augments the user query and returns the augmented user query to the analysis module 103a to determine if sufficient information is now present to formulate a response plan.

If this is the case, the process proceeds to the sixth step 206.

However, if the analysis module 103a determines that the augmented user query still lacks sufficient information to formulate a response plan, it generates a further information request message requesting clarifying information from the user. At a fourth step 204, this further information request message is communicated to the user device 102 via the interface 104.

In this case, at a fifth step 205, on receipt of a further information response from the user device 102, providing further clarifying information, the analysis module 103a determines if there is now sufficient information to formulate a response plan sequence. Assuming this is the case, the process proceeds to the sixth step 206.

However, if this is not the case, the process typically iterates again where the RAG system 103b seeks further clarifying information from the data repository 105 and again if the user query cannot be suitably augmented, another information request can be communicated to the user device 102.

When the process reaches the sixth step 206 once sufficient information has been provided to formulate a response plan sequence, the user query or augmented user query is communicated from the analysis module 103a to the plan sequence generation function 103c which is configured to generate a response plan sequence.

The response plan sequence is then communicated from the plan sequence generation function 103c to the plan execution function 103d which at a seventh step 207 controls the plurality of function-implementing agents 106 to execute the response plan sequence.

Once the plurality of function-implementing agents 106 have generated a final output, this output is passed to the output review function 103e which is configured to perform an output evaluation process in which the output is analysed for completeness, accuracy, and relevance to the original user query. The output review function 103e may further verify that the output meets any predefined quality thresholds, for example relating to the absence of confidential information, profanity, or other inappropriate content.

Assuming this process confirms that the output is an appropriate response to the user query, it is communicated back to the user device 102 via the interface 104.

On the other hand, if the evaluation process performed by the output review function 103e identifies that the output is not appropriate, at a tenth step 210, an error process is triggered. This can be any suitable process, for example logging the error for further analysis, and communicating an error message to the user device 102.

An illustrative example of a user query being handled in accordance with an example of the technique is now provided. In this example, each of the plurality of function-implementing agents are configured to undertake data retrieval and data processing tasks associated with responding to user queries relating to financial and accounting operations. Correspondingly, in such an example, the data repository 105 contains data relating to this domain.

At the first step 201, the analysis module 103a receives the following user query from the user device 102:
“Please identify my best customer based on last quarter's sales.”

At the second step 202, the analysis module 103a analyses this query and identifies that the term “best customer” is potentially unclear. For example, “best” could refer to highest revenue, most frequent purchases, longest relationship, or some other metric.

In response, at the third step 203, the analysis module 103a triggers the RAG system 103b which queries the data repository 105 to determine if a clear definition of the term “best customer” is provided, or a definition of “best” in the context of “customers” is provided.

In the event such clarifying information was found, the user query would be suitably augmented. However, in this example, the RAG system 103b finds no such definition and therefore communicates a failure message to the analysis module 103a. Responsive to this, the analysis module 103a generates the following further information request:
“To identify your ‘best customer,’ could you clarify the criteria? Should it be based on:
   Highest total sales revenue?
   Most frequent purchases?
   Longest duration as a customer?
   Another metric?”

At the fourth step 204, this further information request is communicated from the analysis module 103a to the user device 102 via the interface 104.

In this example, a further information response from the user may be provided from the user device 102 in the following format:
“I mean identify the customer with the highest total sales revenue last quarter.”

At the fifth step 205, this information response is received from the user device 102 via the interface 104 at the analysis module 103a and this, in combination with the original user query, is assessed by the analysis module 103a to determine if there is now sufficient information to formulate a response plan sequence.

In this instance, with the further information response, the analysis module 103a determines that sufficient information is provided, and the user query, augmented with the further information response is then communicated to the plan sequence generation function 103c.

At the sixth step 206 the plan sequence generation function 103c generates a response plan sequence. In this example, the response plan sequence may be as follows:

### Response Plan Sequence

### Step 1: Data Retrieval (SQL Query)

Action: Retrieve raw sales data for all customers from the database for the last quarter.
Function-implementing agent: Data Retrieval Agent
   SQL Query:
      SELECT customer_id, customer_name, sales_amount
      FROM sales_data
      WHERE sale_date BETWEEN ‘2023 Apr. 2’ and AND ‘2023 Jun. 30’
      GROUP BY customer_id, customer_name
      ORDER BY total_sales DESC;
Output: List of sales transactions for each customer during the last quarter.

### Step 2: Calculation

Action: Calculate the total sales revenue for each customer.
Function-implementing agent: Calculation Agent
Input: Retrieved data from Step 1.
Output: List of customers with their corresponding total sales revenue.

### Step 3: Identify Best Customer

Action: Identify the customer with the highest total sales revenue.
Function-implementing agent: Calculation Agent
Input: List of customer sales revenue from Step 2.
Output: Name of the customer with the highest total sales revenue.

### Step 4: Report Generation

Action: Generate a report with the name of the best customer and their total sales revenue.
Function-implementing agent: Report Generation Agent
Input: Name of best customer and their total sales revenue from Step 3.
Output: User-facing report displaying the best customer and total sales revenue.

The plan sequence generation function 103c then communicates this response plan sequence to the plan execution function 103d which then, at the seventh step 207, coordinates the execution of this plan by the plurality of function-implementing agents 106.

In this example, the first function-implementing agent 106a is a data retrieval agent, the second function-implementing agent 106b is a calculation agent, and the third function-implementing agent 106c is a report generation agent.

To execute step 1, the plan execution function 103d passes the instructions defining step 1 of the plan sequence to the first function-implementing agent 106a which, using the SQL query, retrieves the raw sales data for all customers within the defined date range (last quarter). The data includes individual sales transactions (sales_amount) for each customer.

To execute step 2, the plan execution function 103d passes to the second function-implementing agent 106b the instructions defining step 2 of the plan sequence, and the raw sales data retrieved by the first function-implementing agent 106a. The second function-implementing agent 106b calculates the total sales revenue for each customer by summing the individual sales amounts and outputs a list of customers with their corresponding total sales revenue.

To execute step 3, the plan execution function 103d passes to the second function-implementing agent 106b the instructions defining step 3 of the plan sequence along with the list of total sales revenue for each customer previously generated by the second function-implementing agent 106b. The second function-implementing agent 106b identifies the customer with the highest total sales revenue and outputs the name of this customer along with their total sales revenue.

To execute step 4, the plan execution function 103d passes to the third function-implementing agent 106c the instructions defining step 3 of the plan sequence, the name of the customer with the highest total sales revenue, along with their total sales revenue generated by the second function-implementing agent 106b. The third function-implementing agent 106c, acting as the report generation agent, generates a user-facing report displaying the name of the best customer and their total sales revenue. The output produced by the third function-implementing agent 106c may therefore be in the following format:
“Best Customer Report
Customer Name: ABC Corp
Total Sales Revenue: £250,000”

At the eighth step 208, this output is then passed to the output review function 103e, which assuming the output evaluation process validates the output, at the eighth step 2208, then communicates the output to the user device 102 via the interface 104.

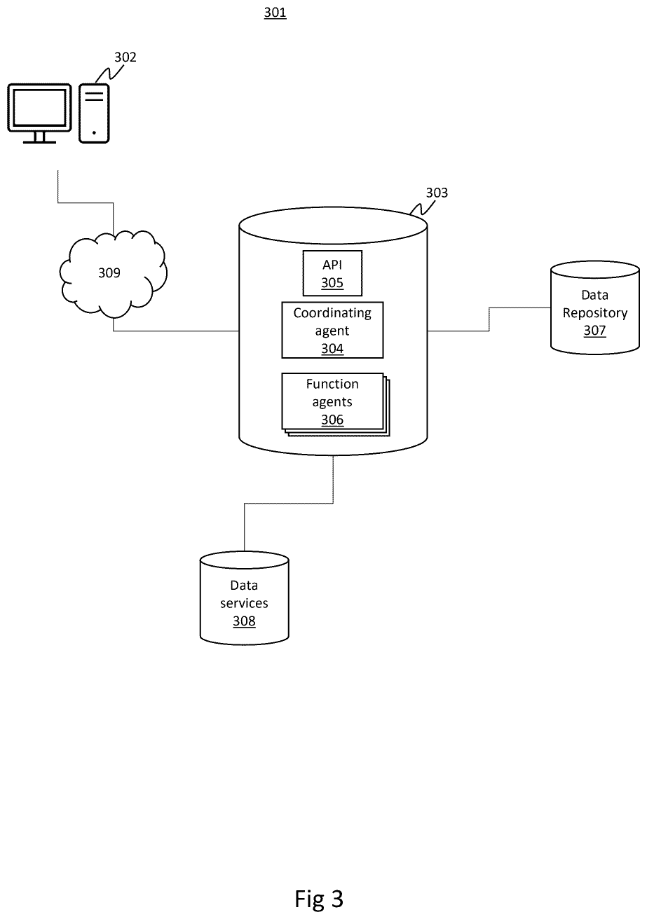

As the skilled person will understand, examples of the invention can be implemented in any suitable way. FIG. 3 provides a simplified schematic diagram depicting an example implementation. FIG. 3 depicts a system 301 comprising a user device 302 and a server system 303 on which hosts software implementing a coordinating agent 304 of the type described above. The server system 303 hosts further software providing an API 305 via which the software running on the user device 302 communicates query data to, and receives response data from, the coordinating agent 304. The server system 303 further hosts software providing a plurality of function-implementing agents 306.

A RAG data database 307 is connected to the server system 303 which provides data storage on which is stored the domain-specific data which the RAG system of the coordinating agent 304 accesses to augment user queries when further information is required to formulate a response plan sequence.

In certain embodiments, the data processing and retrieval services which the plurality of function-implementing agents 306 use to the implement their functions may be hosted fully within the server system 303, however, in the example depicted in FIG. 3, some or all of these services are hosted on software implemented on a further server system 308 coupled to the server system 303.

Data is communicated to and from the user device 302 and the server system 303 via a data network 309.

As the skilled person will appreciate, the components of the system 301 described in FIG. 3 can be implemented in multiple ways depending on the technical and operational requirements.

The user device 302 can be any suitable computing device used to input queries and receive responses. This may include a PC, laptop, smartphone, tablet, smart speaker, wearable device such as a smartwatch, or even a virtual reality (VR) or augmented reality (AR) device, allowing users to interact with the system in different environments. The user device 302 typically has software running thereon providing an interface enabling user queries to be entered by a user and for conveying responses received from the coordinating agent running on the server system 303. This software can be provided in any suitable way, for example, as a dedicated stand-alone software application or via a web browser.

The server system 303 may be hosted on a variety of platforms, such as a physical server, cloud-based server, virtual machine, data centre infrastructure, or server cluster. This flexibility allows the system to scale based on demand and can support distributed architectures if needed.

The RAG data database 307 can be implemented using different types of storage solutions, including an on-premises database server, cloud storage service (e.g., Amazon S3, Google Cloud Storage), or a distributed database (e.g., Cassandra, MongoDB). This allows for efficient storage and retrieval of domain-specific data used by the coordinating agent.

The further server system 308, which hosts additional data processing and retrieval services for the function-implementing agents 306, may also be implemented in various ways. It could be hosted on a remote physical server, cloud-based infrastructure, external data centres, or virtual machines. This system could provide access to specialized computational resources, third-party APIs, or external databases required by the function-implementing agents to execute specific tasks.

Finally, communication between the user device 302 and the server system 303, as well as other system components, is typically facilitated by a data network 309, which may include the internet, a local area network (LAN), a wide area network (WAN), 5G/4G mobile networks, a private VPN, or even satellite networks in certain deployments.

The coordinating agent 103 and plurality of function-implementing agents 106 are typically implemented in software running on server systems such as the server system 303 shown in FIG. 3. The software that implements the coordinating agent 103, and the components thereof including the analysis module 103a, RAG system 103b, plan sequence generation function 103c, plan execution function 103d and output review function 103e can be manifested in any suitable was as is known in the art.

The coordinating agent 103 and the plurality of function-implementing agents 106 can be implemented in software in any suitable way using known techniques. These components can be integrated together or separately, or arranged in different groupings, and they can form part of one or more other software applications. As mentioned above, in certain embodiments, certain components of the coordinating agent 103, for example the analysis module 103a, RAG system 103b, plan sequence generation function 103c and plan execution function 103d may AI models, including large language models (LLMs), to operate. In such examples, one or more suitable models can be incorporated within the coordinating agent 103 or suitable interfacing modules provided within the coordinating agent 103 enabling externally hosted models to be accessed.

All of the features disclosed in this specification (including any accompanying claims, abstract and drawings), and/or all of the steps of any method or process so disclosed, may be combined in any combination, except combinations where at least some of such features and/or steps are mutually exclusive. Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features. The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

It will be appreciated that various embodiments of the present disclosure have been described herein for purposes of illustration, and that various modifications may be made without departing from the scope of the present disclosure. Accordingly, the various embodiments disclosed herein are not intended to be limiting, with the true scope being indicated by the following claims.

1. A computer system for responding to user queries, said system comprising:
a coordinating agent configured to receive from a source device a user query, and
a constrained set of function-implementing agents, each function-implementing agent configured to perform a function; wherein
upon receipt of the user query, the coordinating agent is configured to:
formulate a plan to generate a response to the user query, the plan comprising a sequence in which one or more of the function-implementing agents will be invoked to perform their associated function, and
execute the plan by controlling the function-implementing agents in accordance with the sequence to generate the response to the user query, wherein
the constrained set of function-implementing agents comprises a closed group of function-implementing agents, wherein
the coordinating agent further comprises an analysis module, said analysis module configured to analyse the user query to determine if it contains sufficient information to formulate the plan, and if not, the coordinating agent is configured to undertake a clarification process to obtain further information to augment the user query with further information.

2. A system according to claim 1, wherein the function performed by each function-implementing agent is one of a data retrieval function and a data processing function.

3. A system according to claim 2, wherein the function performed by one or more of the function-implementing agents is a data retrieval function or a data processing function optimised for a predetermined domain.

4. (canceled)

5. A system according to claim 1, wherein the coordinating agent further comprises a RAG system with access to a data repository, wherein the coordinating agent is configured to undertake the clarification process by controlling the RAG system to:
identify if further information is present in the data repository to augment the user query and, if such further information is identified,
augment the user query with the further information, wherein
the coordinating agent is configured to then formulate the plan to generate a response to the augmented user query.

6. A system according to claim 5, wherein
if the RAG system does not identify further information in the data repository to augment the user query, the coordinating agent is configured to:
generate a further information request requesting further information to clarify the user query;
communicate the further information request to the source device from which the user query was received, and on receipt of a further information response comprising further information, and augment the user query with the further information, wherein the analysis module is configured to then analyse the augmented user query to determine if it now contains sufficient information to formulate the plan, and if so
the coordinating agent is configured to then formulate the plan to generate a response to the augmented user query.

7. A system according to claim 1, wherein the source device is a user device operable by a user.

8. A system according to claim 1, wherein the coordinating agent is implemented on a server system remote from the source device.

9. A system according to claim 3, wherein the domain is accounting and finance.

10. A system according to claim 1, wherein the coordinating agent is configured to generate the plan using a generative AI model.

11. A computer implemented method of responding to user queries, said method comprising:
receiving a user query from a source device, and
formulating a plan to generate a response to the user query, the plan comprising a sequence in which one or more function-implementing agents of a constrained set of function-implementing agents, will be invoked to perform a function; wherein
executing the plan by controlling the function-implementing agents in accordance with the sequence to generate the response to the user query, wherein
the constrained set of function-implementing agents comprises a closed group of function-implementing agents, the method further comprising:
analysing the user query to determine if it contains sufficient information to formulate the plan, and if not,
undertaking a clarification process to obtain further information to augment the user query with further information.

12. A method according to claim 11, wherein the function performed by each function-implementing agent is one of a data retrieval function and a data processing function.

13. A method according to claim 12, wherein the function performed by one or more of the function-implementing agents is a data retrieval function or a data processing function optimised for a predetermined domain.

14. (canceled)

15. A method according to claim 11, wherein the step of undertaking the clarification process comprises controlling a RAG system to:
identify if further information is present in the data repository to augment the user query and, if such further information is identified,
augment the user query with the further information,
then formulate the plan to generate a response to the augmented user query.

16. A method according to claim 15, wherein
if the RAG system does not identify further information in the data repository to augment the user query, the method further comprises:
generating a further information request requesting further information to clarify the user query;
communicating the further information request to the source device from which the user query was received, and on receipt of a further information response comprising further information,
augmenting the user query with the further information, then
analysing the augmented user query to determine if it now contains sufficient information to formulate the plan, and if so
formulating the plan to generate a response to the augmented user query.

17. A method according to claim 11, wherein the source device is a user device operable by a user.

18. A method according to claim 13, wherein the domain is accounting and finance.

19. A method according to claim 11, comprising generating the plan using a generative AI model.
